(19) United States
(12) Patent Application Publication
(10) Pub. No.: US 2020/0058071 A1
(43) Pub. Date: Feb. 20, 2020

(54) LEAST DECENTRALIZED FUND TRADING SYSTEM AND METHOD THEREOF

(71) Applicant: SHAO-MING YANG, Taipei City (TW)

(72) Inventor: SHAO-MING YANG, Taipei City (TW)

(21) Appl. No.: 16/283,938

(22) Filed: Feb. 25, 2019

(30) Foreign Application Priority Data
Aug. 16, 2018 (TW) 107128610

(51) Int. Cl. G06Q 40/04; G06Q 20/38

(52) U.S. Cl. CPC G06Q 40/04; G06Q 2220/00; G06Q 20/389

(57) ABSTRACT

A least decentralized fund trading system includes a money pool database and a fund transaction processing system. The money pool database includes an accommodator account and participant accounts. The fund transaction processing system includes a fund matching module, a clearing and settlement module and an encrypted packaging module. The fund matching module matches the transaction-term orders and generates bid/ask matching information. The clearing and settlement module is to perform a clearing process and a settlement process upon the bid/ask matching information with respect to corresponding transaction-term orders and the corresponding participant accounts. The encrypted packaging module bases on a time series of the transaction record to record the transaction receipt or the balance receipt into ledger information, and the encrypted packaging module performs an encryption process upon the ledger information so as to obtain a total root encryption value. In addition, a least decentralized fund trading method is provided.

### CROSS REFERENCE TO RELATED APPLICATION

This application claims the benefit of Taiwan Patent Application Serial No. 107128610, filed on Aug. 16, 2018, the subject matter of which is incorporated herein by reference.

### BACKGROUND OF THE INVENTION

### (1) Field of the Invention

The invention relates to a least-decentralized fund trading system and a method thereof.

### (2) Description of the Prior Art

In free economy, fund demand and supply play one of important roles in a capital and money market. In a typical capital and money market, versatile financial instruments such as funds, bonds, stocks, futures, options and the like merchandises, can be provided for participants to optionally prosecute related transactions.

Among all the aforesaid financial instruments, the mutual fund (called as fund thereafter) is introduced to raise capital from inventors in a form of beneficiary certificates issued by a professional securities investment trust company (called as fund company thereafter), the raised capital is then kept in a custodian institution for a professional fund manager to comply with the regulation of the asset management. In the case that certain profit are generated, the investor will share the profit according to his/her own invented capital. A major difference between the fund and the other direct investments such as Exchanges and stocks, is that the capital of the investor is not directly used to purchase certain financial instruments (such as stocks and bonds), but is used to buy or sell beneficiary certificates issued by the fund company. That is to say, the investor invests the merchandise or money market through purchasing the beneficiary certificates of the fund, and then a professional manager of the fund is authorized to manage the raised or collected capital for the fund to perform further investments. Daily profit and loss are calculated to derive a net asset value, and the net asset value is announced everyday by the fund company. The appearance of mutual funds is due to a need for the investor to contribute his/her money into a risk-diversifying investment portfolio; i.e., the fund. By collecting little capitals to form a fund pool for earning more money through purpose investments, then enough capital can be collected, possible investment risks can be diffused, and profits can be shared. Importantly, the most remarkable feature of the fund is to diversify the risk of the investment portfolio.

The fund trading is usually executed and accounted by a single institution such as a bank or a clearing house. Basically, the system in the financial institution for running the fund is a close system with a centralized architecture. However, the fund trading within a centralized architecture is accompanied by the following problems: 1. If the single institution is invaded or hacked, the entire trading system could be shut down, transaction records may be purposely falsified, and thus accuracy of the transaction information could be problems; 2. Since inconsistency in the trading logics and data formats is possible due to various self-configured transaction processes provided by different institutions, much longer time is needed for the clients to confirm and/or reconciliate details of specific transactions; (Generally, to verify one single transaction from the entire transaction data, days of work could be needed, and thus trading audit would be less efficient); 3. While in redeeming the fund, tedious operations would be involved and quite possible to delay further purchase (Generally, 5-7 working days can be expected); 4. While in purchasing the fund, transaction fees up to 3% per each transaction shall pay to brokers such as the fund company or fund retailers, and also around 3 working days are needed for settling the purchase unit; and, 5. Since the fund is traded by units, thus a least trade unit is usually enforced for purchasing of redeeming, from which easy or arbitrary trading is difficult to some degree (Namely, a purchase or redemption less than a trade unit would be impossible).

In summary, since the current art in fund trading is performed according to the aforesaid centralized architecture, thus the foregoing shortcomings in fund trading are inevitable at least. Thus, an improvement to provide “a least decentralized fund trading system and a method thereof” for waiving the aforesaid shortcomings is definitely urgent to the art.

### SUMMARY OF THE INVENTION

Accordingly, it is an object of the present invention to provide a least decentralized fund trading system and a method thereof. Without altering the existing foreign conventional fund trading system, the least decentralized fund trading system and the method thereof provided by the present invention establish an internal blockchain fund trading ecosystem to perform a new model of fund trading; i.e., the least decentralized model, in comparison with the conventional fund trading model who is 100% centralized. In the art, advantages of the centralized model are in transaction confirmation, privacy protection are financial supervision. On the other hand, advantages of the decentralized model are in public trust, anonymous transactions, accuracy and transparency. Apparently, both of which have their own advantages. However, with the particular financial supervision and regulations, complete decentralization is practically not true, and can't satisfy the reality. For example, if somebody's asset is enforcedly seized, then, in a decentralized world, nobody can execute the enforcement without an agreement from the somebody. At this time, a centralized mechanism can make it through to meet the legal and supervisory demands and so to complete the enforcement. Furthermore, in the transaction process, consensus is not necessary to everything, and it does not mean that everything shall record on blockchain. Therefore, the present invention introduces a hybrid model to extract merits from individual models. This hybrid model of fund trading is herein assigned as the name of a least decentralized fund trading system, which is mainly structured to follow the decentralized model but amended by the centralized model.

In the present invention, the least decentralized fund trading system includes a money pool database and a fund transaction processing system. The money pool database includes an accommodator account and a plurality of participant accounts. Each of the plurality of participant accounts is to raise transaction-term orders. Each of the fund transaction-term orders contains at least one of a buy order and a sell order, where the buy order and the sell order contain at least one fund with corresponding trading units. The fund transaction processing system, coupled with the money pool database, includes a fund matching module, a clearing and settlement module and an encrypted packaging module. The fund matching module matches each of the transaction-term orders and generates at least one bid/ask matching information within an N-th time unit. The fund matching module pairs the buy order and an inter-offsetable sell order into the matching. The “inter-offsetable” indicates that a predetermined conversion ratio exists in the trading units between the buy order and the sell order. For a difference existing between the buy order and the respective sell order that can't be inter-offset by the fund matching module, the accommodate account handles a reverse offset-balance operation upon the difference so as to generate corresponding bid/ask matching information, in which the difference is directed to the respective balance after inter-setting upon the buy order and the respective sell order, and the N is greater than or equal to 1. The clearing and settlement module receives the at least one bid/ask matching information so as further to perform clearing process the clearing and settlement procedure upon each of the at least one bid/ask matching information with respect to the corresponding transaction-term orders and the corresponding participant accounts, so that a transaction record is generated in correspondence with the at least one bid/ask matching information, the transaction record containing a transaction receipt and a balance receipt. The encrypted packaging module for receiving the transaction receipt or the balance receipt of the corresponding transaction record bases on a time series of the transaction record to record the transaction receipt or the balance receipt with respect to the transaction record into at least one ledger information, and the encrypted packaging module performs an encryption process upon the at least one ledger information so as to obtain a total root encryption value. The fund transaction processing system connects a public blockchain, the public blockchain links a plurality of blocks in a blockchain manner, the public blockchain receives the total root encryption value transmitted by the encrypted packaging module, the total root encryption value is recorded into a digital tag value of a j-th block of the plurality of blocks in the public blockchain, the j is greater than 1, and the digital tag value is equal to the total root encryption value.

In one embodiment of the present invention, the accommodator account trades with an exchange institution so as to obtain the fund with the trading units with respect to the difference, and performs a reverse offset-balance handle upon the difference.

In one embodiment of the present invention, the clearing process obtains the fund, the associated trading units of the fund, and corresponding money cleared by the clearing and settlement module with respect to the bid/ask matching information, the settlement process obtains the fund, the associated trading units of the fund, and corresponding money delivered by the participant account with respect to the bid/ask matching information, the clearing and settlement module bases on the bid/ask matching information to transfer the fund with the associated trading units among the plurality of participant accounts within the transaction-term order so as to obtain the transaction receipt, and the clearing and settlement module further transmits the transaction receipt to the participant accounts within the transaction-term order and generates corresponding balance receipt with respect to the fund with the associated trading units and the corresponding money in the transaction receipt.

In one embodiment of the present invention, the encrypted packaging module bases on a number of the at least one ledger information to encrypt the ledger information into a root encryption value, the root encryption value is respective only to the transaction receipt or the balance receipt with respect to the transaction record in the ledger information, the encrypted packaging module keeps encrypting again at least two said root encryption values, and a cycling encryption keeps going till the number of the root encryption values equal to 1, such that the total root encryption value is obtained.

In one embodiment of the present invention, the least decentralized fund trading system further includes an audit system connected with the fund transaction processing system and the public blockchain. The audit system performs verification and inspection upon the transaction receipt or the balance receipt in the at least one ledger information of the fund transaction processing system.

In one embodiment of the present invention, the audit system bases on the digital tag value in the public blockchain to verify the total root encryption value.

In one embodiment of the present invention, the audit system performs verification and inspection upon the root encryption value corresponding to the participant account and the root encryption value related to the cycling encryption process.

In the present invention, the least decentralized fund trading method includes the steps of: (a) one of a plurality of participant accounts raising a transaction-term order, the transaction-term order containing at least one of a buy order and a sell order, each of the buy order and the sell order containing at least one fund with corresponding trading units; (b) a fund matching module being introduced to match the transaction-term order, at least one bid/ask matching information being generated within a N-th time unit, the N being greater than or equal to 1; (c) a clearing and settlement module being used to perform a clearing process and a settlement process upon the at least one the bid/ask matching information according to the transaction-term order and the corresponding participant account, so as to generate a transaction record with respect to the at least one bid/ask matching information, the transaction record containing a transaction receipt and a balance receipt; (d) according to a time series of the transaction record, an encrypted packaging module being used to record the transaction receipt or the balance receipt of the transaction record into at least one ledger information; (e) the encrypted packaging module being used to perform an encryption process upon the at least one ledger information so as to obtain a total root encryption value; and (f) the public blockchain receiving the total root encryption value transmitted by the encrypted packaging module, the total root encryption value being recorded into a digital tag value of a j-th block in the public blockchain, the j being greater than 1, the digital tag value being equal to the total root encryption value.

in one embodiment of the present invention, the step (b) includes the steps of :the step (b) includes the steps of: (b1) the fund matching module pairing the buy order and an inter-offsetable sell order out of the sell order into the bid/ask matching information, the “inter-offsetable” indicating that a predetermined conversion ratio exists in the trading units between the buy order and the sell order; and (b2) for a difference existing between the buy order and the respective sell order that can't be inter-offset by the fund matching module, the accommodate account handle a reverse offset-balance operation upon the difference so as to generate corresponding bid/ask matching information, the difference being directed to the respective balance after inter-setting upon the buy order and the respective sell order.

In one embodiment of the present invention, the reverse offset-balance handle includes a step of the accommodator account trading with an exchange institution so as to obtain the fund and the trading unit corresponding to the difference, and then performing the reverse offset-balance handle upon the difference.

In one embodiment of the present invention, the step (c) includes the steps of: (c1) the clearing and settlement module basing on the bid/ask matching information to transfer the fund with the trading units among the participant accounts corresponding to the transaction-term order and further to obtain the transaction receipt; (c2) the clearing and settlement module transmitting the transaction receipt to the participant accounts corresponding to the transaction-term order; and (c3) the clearing and settlement module obtaining the balance receipt according to an equivalent money and the trading units of the fund.

In one embodiment of the present invention, the clearing process and the settlement process of the step (c) includes: a step of the clearing process obtaining the fund, the associated trading units of the fund, and corresponding money cleared by the clearing and settlement module with respect to the bid/ask matching information; and a step of the settlement process obtaining the fund, the associated trading units of the fund, and corresponding money delivered by the participant account with respect to the bid/ask matching information.

In one embodiment of the present invention, the step (e) includes the steps of: (e1) the encrypted packaging module basing on a number of the at least one ledger information to encrypt the ledger information into a root encryption value, the root encryption value is respective only to the transaction receipt or the balance receipt with respect to the transaction record in the ledger information; and (e2) the encrypted packaging module keeping encrypting again at least two said root encryption values, and a cycling encryption keeping going till the number of the root encryption values equal to 1, such that the total root encryption value is obtained.

In one embodiment of the present invention, the least decentralized fund trading method further includes the steps of: an audit system being introduced to perform verification and inspection upon the transaction receipt or the balance receipt in the at least one ledger information; and the audit system performing verification and inspection upon the root encryption value corresponding to the participant account and the root encryption value related to the cycling encryption process.

In one embodiment of the present invention, the step (e) includes a step of the audit system basing on the digital tag value in the public blockchain to verify the total root encryption value.

As stated, the least decentralized fund trading system and the method thereof in accordance with the present invention provides a low entry-level. By waiving the involvement of distributors and frequent transactions collected by the brokers for every transaction can be saved. The participant account can perform fund trading in an exchange on the least decentralized fund trading system of the present invention. By providing the sub-ledger management, the recording and the encryption of the present invention to the fund trading process, the ledger information can then be furnished with integrity, encryption, incorruptibility, non-repudiation and traceability, the verification can be trustable, and the trading information can be kept accurately. In addition, through the public blockchain to perform discrete storage, the least decentralized fund trading system provided by the present invention can be publicly supervised and privately supervised (by the participant). Further, safety, impartiality and transparency of the least decentralized fund trading system can be confirmed.

All these objects are achieved by the least decentralized fund trading system and a method thereof described below.

### BRIEF DESCRIPTION OF THE DRAWINGS

The present invention will now be specified with reference to its preferred embodiment illustrated in the drawings, in which:

FIG.1 is a schematic view of the preferred least decentralized fund trading system in accordance with the present invention.

### DESCRIPTION OF THE PREFERRED EMBODIMENT

The invention disclosed herein is directed to a least decentralized fund trading system and a method thereof. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the present invention, the least decentralized fund trading system and a method thereof are applicable to a network of a computer code protocol that can meet a requirement of able to fulfill automatically bilateral preset conditions. For example, a transmission protocol is formed by processes performed in a clearing and settlement module and an encrypted packaging module, and a bi-directional communication is then established between the transmission protocol and a public blockchain to serve bridging flow of booking transactions transferred from the transmission protocol to the public blockchain or from the public blockchain back to check the transmission protocol, so that bi-directional data flow and check can be obtained. The computer code protocol that can meet the requirement of able to fulfill automatically bilateral preset conditions is a calculator protocol that broadcasts, verifies or executes contracts in an informatization manner, and also a computer program that executes commands or instruction according to predetermined conditions and transmitted information. In one embodiment, the computer code protocol that can meet the requirement of able to fulfill automatically bilateral preset conditions can be organized by specific program languages such as solidity, serpent, LLL, EtherScript, Sidechain or the like, and can contain various events, functions, parameters and the like. Hence, the protocol allows trustable transactions even without the involvement of a third party. Besides responding to the received messages, the protocol can also receive and store messages, and also can send messages. In other words, the computer code protocol that can meet the requirement of able to fulfill automatically bilateral preset conditions is a computer program for the duplicable and shared ledger to receive, process, store and issue messages.

Further, the blockchain technology is a conceptual verification of the decentralized trading system, and is an encrypted electronic recording method. In the present invention, the least decentralized fund trading system and a method thereof, applicable to a network of a computer code protocol that can meet a requirement of able to fulfill automatically bilateral preset conditions, can have the barter process (exchanging of goods) to be directly initiated by one party for triggering another party to execute the trading. During the aforesaid process, neither broker nor third party is needed anymore. The blockchain technology can adopt Hashcash algorithms to perform calculations, so that each node in the blockchain can participate the verification process so as to reach a state of asymmetric encryption. In the art, the blockchain technology has at least the following technical features: a P2P (Peer to Peer) network architecture and an asymmetric encryption technique. The P2P network architecture, different to the conventional centralized network architecture, is one of the blockchain technology to establish connections between nodes. With the P2P network architecture, each node poses the same status; i.e., the same internet computing power. Through the protocol, every node can share the computation resource, software or messages. The asymmetric encryption technique uses public keys and private keys to encrypt and decrypt the transmitted messages. The public key can be issued publicly, and is used for the sender to transmit the encrypted message. The private key is used for the receiver to decrypt the received encrypted message. The blockchain technology utilizes the asymmetric encryption technique to preserve the trust relationship among the nodes.

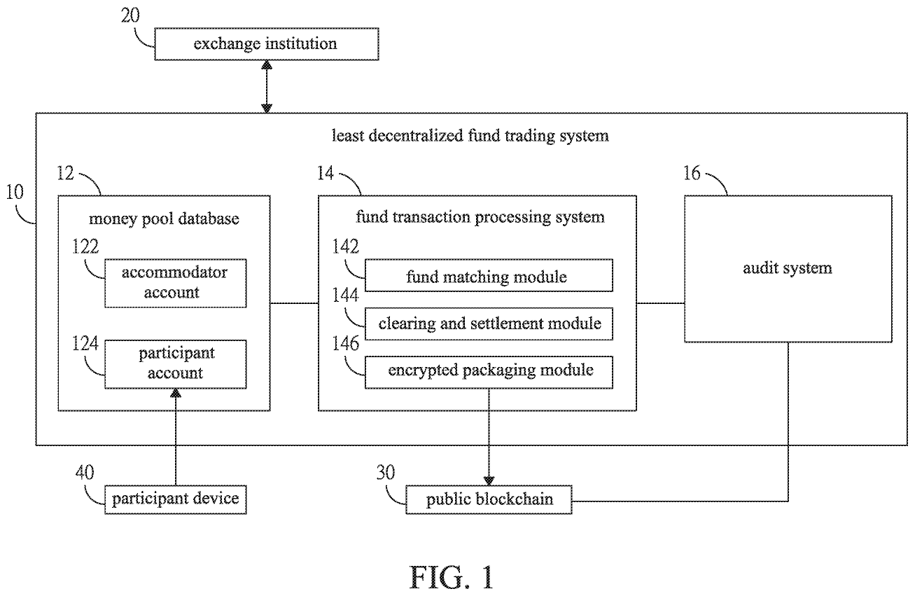

Referring now to FIG. 1, a schematic view of the preferred least decentralized fund trading system in accordance with the present invention is shown. The least decentralized fund trading system 10 can utilize computer web pages or application programs (APP) to present on a computer equipment with a specific type of operation system such as Windows, Android or IOS. In the present invention, the computer equipment can be a server, a main computer, a notebook computer, a tablet computer, a smart phone, or any the like with a wireless transmission interface.

In this embodiment, the least decentralized fund trading system 10 can be coupled in a network manner to an exchange institution 20 and a plurality of participant devices 40 (one shown in FIG. 1). As shown, the least decentralized fund trading system 10 includes a money pool database 12, a fund transaction processing system 14 and an audit system 16. The money pool database 12 is to perform communication connections and logic judgments through hardware (an IC for example), software (programmed commands executed by a processor for example) or a combination of hardware and software. The money pool database 12 further includes an accommodator account 122 and a plurality of participant accounts 124.

In this embodiment, the accommodator account 122 can be an account of the least decentralized fund trading system 10 itself or an impartial third party served by a natural person or a legal entity. This embodiment can utilize the accommodator account 122 to perform at least one fund-trading transaction (including type(s) of fund(s) and corresponding trading units) with the Exchange institution 20 so as to obtain registered fund beneficiary certificates. The Exchange institution 20 can be, but not limited to be, a financial institution such as a custodian bank, a fund house, a depository and clearing corporation, or a combination of foregoing institutions. It shall be explained that any trading process (such as placing a trading order, opening an account, delivering, reconciling, or settling) between the accommodator account 122 of the least decentralized fund trading system 10 and the aforesaid Exchange institution 20 is generally a conventional investment transaction process, which is not an issue of this present invention. Thus, details thereabout would be omitted herein.

In this embodiment, any participant (a natural person or a legal entity for example) can utilize a relevant web site or APP to serve as the participant device 40. Every participant to utilize the participant device 40 should apply online an account from the least decentralized fund trading system 10 in advance. After the account opening is finished to become as one of the participant accounts 124, then depositing and placing an order can be proceeded. In the present invention, the qualified participant account 124 can place a transaction-term order on the least decentralized fund trading system 10. Each of the transaction-term orders contains a buy order or a sell order. The investor can use the participant account 124 to purchase or sell the funds by himself/herself via the least decentralized fund trading system 10. In a typical trading process on the least decentralized fund trading system 10, all the sell and/or buy order s (transaction-term orders of fund trading) raised within a time unit (the N-th time unit for example) through the participant accounts 124 would be processed at the same time, in which the N is greater than or equal to 1. In the present invention, the time unit is one day. In some other embodiments, the time unit may be 12 hours or else per practical requirements. It shall be explained that, in the aforesaid fund trading, all the participant accounts 124 would transfer the rights of involved funds to the least decentralized fund trading system 10 in advance, and then the least decentralized fund trading system 10 would perform a book-keeping of exchange or transfer of rights in a blockchain manner. Alternatively, if the rights of involved funds are registered in a depository and custodian banks or the like, the depository and custodian banks would shift the corresponding authority to the least decentralized fund trading system 10. Namely, the participant account 124 originally as a participant holding the funds and corresponding trading units would be seen now as a holder of related digital record on the least decentralized fund trading system 10, in which the digital record is corresponding to the funds and corresponding trading units substantially own by the participant account 124. Nominally, the least decentralized fund trading system 10 of the present invention owns, or is authorized at least to execute, the rights of funds.

In this embodiment, the fund transaction processing system 14, coupled with the money pool database 12, is also to perform communication connections and logic judgments through hardware (an IC for example), software (programmed commands executed by a processor for example) or a combination of hardware and software. The fund transaction processing system 14 includes a fund matching module 142, a clearing and settlement module 144 and an encrypted packaging module 146. The fund matching module 142 is to match individual transaction-term orders, and to generate at least one bid/ask matching information within the N-th time unit (for example), in which the N is greater than or equal to 1. In the present invention, the time unit is one day. In some other embodiments, the time unit may be 12 hours or else per practical requirements. The fund matching module 142 can pair the buy order and the inter-offsetable sell order into a corresponding bid/ask matching information. The term “inter-offsetable” indicates that a predetermined conversion ratio exists in the trading units between the buy order and the sell order. For example, if the buy order and the sell order are directed to the same fund, then the conversion ratio would be 1. On the other hand, if the types of the fund for the buy order and the sell order are different, then the conversion ratio would be a specific ratio other than 1. Thereupon, the aforesaid matching of funds can prevail to various types of fund, and thus the corresponding time efficiency of matching for the method provided by this invention can be substantially enhanced. In addition, for differences between the buy order s and the respective sell orders that can't be inter-offset by the fund matching module 142, the accommodate account 122 would handle reverse offset-balance operations individually upon the differences so as to generate corresponding bid/ask matching information. Herein, the foregoing differences are directed to the respective balances after individual inter-setting operations upon the buy order s and the respective sell orders with different trading units. In particular, the accommodator account 122 would communicate with the Exchange institution 20 for obtaining the necessary funds and the necessary trading units to compensate the aforesaid difference(s), such that the handle in a reverse offset-balance manner upon the difference(s) can be performed.

For example, if a participant account 124 raises a buy order by a transaction-term order, then the fund matching module 142 would base on the transaction-term order to search other participant accounts 124 and see whether or not a transaction-term order of sell order exists. If the transaction-term order of the buy order and that of the sell order are matched in both the funds and the corresponding trading units, then the fund matching module 142 would pair the inter-offsetable buy order and sell order into a bid/ask matching information. Here, the term “inter-offsetable” indicates that a predetermined conversion ratio exists in the trading units between the transaction-term order of the buy order and that of the sell order, and the conversion ratio is 1. If the transaction-term order of the buy order and that of the sell order are not matched in the funds but the same in the trading units, then the conversion ratio would be a specific ratio other than 1. At this time, based on the conversion ratio and specific percentages of the funds to be traded, the fund matching module 142 can still perform the aforesaid matching upon the buy order and the sell order able to be inter-offset so as to generate a corresponding bid/ask information. If the transaction-term order of the buy order and that of the sell order are matched in the funds but not in the respective trading units, then the fund matching module 142 would extract those unmatched trading units of the matched funds from the buy order, and the accommodator account 122 and the Exchange institution 20 would form a trading order corresponding to the unmatched trading units of the matched funds. After the registered fund beneficiary certificates are obtained, the accommodator account 122 will not trade these fund beneficiary certificates directly, but utilizes the substantive beneficial ownership derived from the corresponding fund beneficiary certificates to perform the reverse offset-balance handle upon the aforesaid unmatched trading units and further to form a corresponding bid/ask matching information. It shall be explained that, though the aforesaid examples are based on the transaction-term order of the buy order placed by the participant account 124, yet similar operation process can be applied to the transaction-term order of the sell order placed by the participant account 124. Thus, details thereabout would be omitted herein.

In this embodiment, the clearing and settlement module 144 receives at least one bid/ask matching information so as further to perform a clearing process and a settlement process upon each individual bid/ask matching information with respect to the corresponding transaction-term orders and individual participant accounts 124. In the present invention, the clearing process and the settlement process are integrally called as the settling process. After the settling process is finished, a transaction record would be generated in correspondence with the at least one bid/ask matching information. In this embodiment, each of the transaction records contains a transaction receipt and a balance receipt. The clearing process is to obtain the funds, the associated trading units of the funds, and the corresponding money cleared by the clearing and settlement module 124 with respect to individual bid/ask matching information. The settlement process is to obtain the funds, the associated trading units of the funds, and the corresponding money delivered by the individual participant account 124 with respect to individual bid/ask matching information. Based on the bid/ask matching information, the clearing and settlement module 144 transfers at least one fund with the associated trading units among the participant accounts 124 within each transaction-term order, obtains corresponding transaction receipts, further transmits individual transaction receipts to the participant accounts 124 within the corresponding transaction-term order, and generates corresponding balance receipt with respect to the at least one fund with the associated trading units and the corresponding money in each individual transaction receipt.

For example, a specific participant account 124 places a transaction-term order of a buy order to purchase 100 trading units of the gold fund. The fund matching module 142 searches and finds a sell order at another participant account 124 able to inter-offset the buy order , and then a bid/ask matching information is formed based on the inter-offset purchase and sell orders. The clearing and settlement module 144 bases on the bid/ask matching information to subtract 100 trading units of the gold fund from the another participant account 124, and to add corresponding equivalent money to the another participant account 124. Also, a new balance of the trading units of the gold fund at the another participant account 124 would be shown. Thus, the transaction receipt or the balance receipt corresponding to the another participant account 124 can be obtained. On the other hand, the same equivalent money for purchasing the 100 trading units of the gold fund would be subtracted from the specific participant account 124, and also the new 100 trading units of the gold fund would added into the specific participant account 124. Thereby, the transaction receipt or the balance receipt corresponding to the specific participant account 124 can be obtained.

It shall be explained that, in this embodiment, while the clearing and settlement module 144 receives at least one bid/ask matching information, encryption upon the bid/ask matching information is not necessary. In this embodiment, while the clearing and settlement module 144 performs the clearing process and the settlement process, the transaction receipt or the balance receipt in the transaction records of the clearing process and the settlement process is not encrypted. In some other embodiments, the transaction receipt or the balance receipt in the transaction records of the clearing process and the settlement process can be encrypted. The aforesaid encryption includes, but not limited to, the asymmetric cryptography, and the related algorithm includes, but not limited to, the irreversible encryption algorithm.

In this embodiment, within the N-th time unit, at least one bid/ask matching information is generated, and corresponding transaction records are generated by the clearing and settlement module 144. The encrypted packaging module 146, for receiving the transaction receipts and/or the balance receipt of the corresponding individual transaction records, would base on a time series of each individual transaction records to record the transaction receipts and/or the balance receipt with respect to each of the transaction records into at least one ledger information. Thereupon, each of the authorized participant accounts 124 can record digitally its own funds with associated trading units in at least one ledger information. Then, the encrypted packaging module 146 performs an encryption process upon a plurality of ledger information so as to obtain a total root encryption value. In detail, the encryption process includes the following steps. Firstly, the encrypted packaging module 146 bases on the number of the at least one ledger information to encrypt individual ledger information into a root encryption value, in which the root encryption value is respective only to the transaction receipts or the balance receipt with respect to individual transaction records in the ledger information. That is to say, each of the ledger information is mapped to a root encryption value. If a participant account 124 or some other accounts alter or falsify the transaction receipts or the balance receipt of any transaction record in a specific ledger information, then the root encryption value would fail to map the altered transaction records in the specific a ledger information. Then, the encrypted packaging module 146 would treat each of the root encryption values as a leaf node of a Merkle tree. The encrypted packaging module 146 would keep encrypting again at least two root encryption values. The cycling encryption would keep going till the number of the root encryption value equal to 1, such that a total root encryption value is obtained. In other words, the encrypted packaging module 146 uses an encryption algorithm to perform repeating encryption orderly from a single leaf node to every level of nodes, till the last node is encrypted. Namely, the cycling encryption algorithm is executed level by level from the leaf node to the root node, and thus the total root encryption value is obtained. The foregoing encryption includes, but not limited to, the asymmetric cryptography, and the adopted algorithm includes, but not limited to, the irreversible encryption algorithm. If a participant account 124 or some other accounts alter or falsify the transaction receipts or the balance receipt of any transaction record in a specific ledger information, then the root encryption value would be altered as well. This altered total root encryption value would be never able to map the original total root encryption value. By providing the sub-ledger management, the recording and the encryption of the present invention, the ledger information can then be furnished with integrity, encryption, incorruptibility, non-repudiation and traceability, the verification can be trustable, and the trading information can be kept accurately.

In one embodiment, the encrypted packaging module 146 would keep receiving the transaction receipts with respect to individual transaction records, the transaction receipts of each transaction record would be stored through the aforesaid Merkle tree to generate a transaction receipt tree, and the total root encryption value would be transmitted to the network of a computer code protocol that can meet a requirement of able to fulfill automatically bilateral preset conditions. Then, the following participant accounts 124 would be easily verified and inspected. Similarly, the encrypted packaging module 146 would keep receiving the balance receipt with respect to individual transaction records, the balance receipt of each transaction record would be stored through the aforesaid Merkle tree so as to generate a receipt balance tree. Upon when the transaction receipt of each transaction record is received, each the transaction receipt is used to dynamically update the receipt balance tree, and the total root encryption value would be transmitted to the network of a computer code protocol that can meet a requirement of able to fulfill automatically bilateral preset conditions. Then, the following participant accounts 124 would be easily verified and inspected.

In this embodiment, the audit system 16, connected with the fund transaction processing system 14 and the public blockchain 30, is to perform verification and inspection upon the transaction receipts or the balance receipt in the at least one ledger information of the fund transaction processing system 14. Thereby, the verification can be trustable, and the trading information can be kept accurately. Also, loss to the participants caused by fraud and error booking can be substantially reduced. In addition, after all the transaction-term orders raised by individual participant accounts 124 have been received and fulfilled, corresponding transaction receipts would be obtained. To the transaction records corresponding to private transaction-term orders, the owner of the private transaction-term orders would have the right to audit the corresponding transaction receipts. Also, when the participant account 124 retrieves the root encryption values related to his/her own account, related encrypted information related to other participant accounts 124 would be retrieved as well. Hence, while any participant account 124 performs verification and auditing upon his/her own account, accounts of the other participant accounts 124 are also audited. As long as information of any leaf node is falsified, the derived total root encryption value would be inconsistent. In other words, besides the audit system 16 can perform verification and inspection upon the root encryption values of the individual participant accounts 124 and the root encryption value related to the cycling encryption process, the calculation result of the total root encryption value which is irreversible and highly difficult to be falsified is also provided to verify the consistency. If all the verifications are well, it implies that information provided by the Merkle tree, standing for the verification result, is correct. In the present invention, the participant account 124 is allowed to initiate an audit. The audit initiated by one participant account 124 is equivalent to an audit upon all other participant accounts 124. The audit through the root encryption value is similar to an identification using a scientific method, in which no appearance, voice or DNA is needed, but only the fingerprint. In the present invention, similar concept is applied to the audit system 16. Thereupon, accuracy and fairness for the information verification can be assured, and wisely personal information and privacy of each participant account 124 can be well protected.

In this embodiment, the fund transaction processing system 14 is connected with the public blockchain 30. The public blockchain 30 links a plurality of blocks according to a blockchain technique. In each block of the public blockchain 30, a block header and an encrypted hash value of a preceding block can be included. The block header would contain a preceding digital tag value calculated from the block header of the preceding block, a digital tag value of the instant block and nonce. Every block is encrypted, furnished with a timestamp, and then broadcasted. Thereby, the instant block can link with information of the preceding block, and also the correctness of the block series and historic record can be secured. This is the key connection to form the chain of blocks. The public blockchain 30 receives the total root encryption value transmitted from the encrypted packaging module 146, and the total root encryption value is recorded to a digital tag value of the j-th block in the public blockchain 30, where j>1. The digital tag value is published in a blockchain manner, highly difficult to be falsified, and always equal to the total root encryption value. In this embodiment, the audit system 16 bases on the digital tag value of the public blockchain 30 to verify the total root encryption value. Contrarily, the aforesaid encrypted packaging module 146 can only receive the total root encryption value. In the present invention, all transaction records are in the least decentralized fund trading system 10, and thus no one can peer detail information of a transaction simply by the total root encryption value recorded in the public blockchain 30. Thus, if anyone falsified the data in the conventional transmission protocol, then the derived total root encryption value would be unable to be consistent with the digital tag value of the public blockchain 30. Hence, the present invention can use the public blockchain to perform discrete storage. With the feature of open audit, the least decentralized fund trading system 10 provided by the present invention can be publicly supervised and privately supervised (by the participant). Namely, both private information of the participant and the transaction privacy can be well protected, and also safety, impartiality and transparency of the least decentralized fund trading system 10 can be true.

In this embodiment, the least decentralized fund trading method, relied on the least decentralized fund trading system 10 of FIG. 1, includes the following steps. Firstly, a participant uses the participant device 40 to open online an account on the least decentralized fund trading system 10. After completing the process of account opening to become a participant account 124, then depositing and placing an order can be performed. Then, each of the participant accounts 124 can raise a transaction-term order on the least decentralized fund trading system 10, where the transaction-term order contains a buy order or a sell order. The participant can use the participant account 124 to raise a fund purchase and/or sell on the least decentralized fund trading system 10. Then, the fund matching module 142 is introduced to match the transaction-term orders. Within the N-th time unit, at least one bid/ask matching information is generated, where N is greater than or equal to 1, and the time unit is a day. In some other embodiments, the time unit can be 12 hours or any time duration per practical requirements. In detail, the fund matching module 142 can pair the buy order and the inter-offsetable sell order into a corresponding bid/ask matching information. The term “inter-offsetable” indicates that a predetermined conversion ratio exists in the trading units between the buy order and the sell order. For example, if the buy order and the sell order are directed to the same fund, then the conversion ratio would be 1. On the other hand, if the types of the fund for the buy order and the sell order are different, then the conversion ratio would be a specific ratio other than 1. Thereupon, the aforesaid matching of funds can prevail to various types of fund, and thus the corresponding time efficiency of matching for the method provided by this invention can be substantially enhanced. In addition, for differences between the buy order s and the respective sell orders that can't be inter-offset by the fund matching module 142, the accommodate account 122 would handle reverse offset-balance operations individually upon the differences so as to generate corresponding bid/ask matching information. Herein, the foregoing differences are directed to the respective balances after individual inter-setting operations upon the buy orders and the respective sell orders with different trading units. In particular, the accommodator account 122 would communicate with the Exchange institution 20 for obtaining the necessary funds and the necessary trading units to compensate the aforesaid difference(s), such that the handle in a reverse offset-balance manner upon the difference(s) can be performed.

Then, the clearing and settlement module 144 receives at least one bid/ask matching information. In this embodiment, while the clearing and settlement module 144 receives at least one bid/ask matching information, encryption upon the bid/ask matching information is not necessary. The clearing and settlement module 144 for matching sell/purchase information performs a clearing process and a settlement process according to individual transaction-term orders and individual participant accounts 124. In the present invention, the clearing process and the settlement process are integrally called as the settling process. After the settling process is finished, a transaction record would be generated in correspondence with the at least one bid/ask matching information. In this embodiment, each of the transaction records contains a transaction receipt and a balance receipt. In this embodiment, while the clearing and settlement module 144 performs the clearing process and the settlement process, the transaction receipt or the balance receipt in the transaction records of the clearing process and the settlement process is not encrypted. In some other embodiments, the transaction receipt or the balance receipt in the transaction records of the clearing process and the settlement process can be encrypted. In detail, the clearing process is to obtain the funds, the associated trading units of the funds, and the corresponding money cleared by the clearing and settlement module 124 with respect to individual bid/ask matching information. The settlement process is to obtain the funds, the associated trading units of the funds, and the corresponding money delivered by the individual participant account 124 with respect to individual bid/ask matching information. Based on the bid/ask matching information, the clearing and settlement module 144 transfers at least one fund with the associated trading units among the participant accounts 124 within each transaction-term order, obtains corresponding transaction receipts, further transmits individual transaction receipts to the participant accounts 124 within the corresponding transaction-term order, and generates corresponding balance receipt with respect to the at least one fund with the associated trading units and the corresponding money in each individual transaction receipt. It shall be explained that, in the present invention, the aforesaid encryption includes, but not limited to, the asymmetric cryptography, and the related algorithm includes, but not limited to, the irreversible encryption algorithm.

Then, the encrypted packaging module 146, for receiving the transaction receipts and/or the balance receipt of the corresponding individual transaction records, would base on a time series of each individual transaction records to record the transaction receipts and/or the balance receipt with respect to each of the transaction records into at least one ledger information. Then, the encrypted packaging module 146 performs an encryption process upon a plurality of ledger information so as to obtain a total root encryption value. In detail, the encryption process includes the following steps. Firstly, the encrypted packaging module 146 bases on the number of the at least one ledger information to encrypt individual ledger information into a root encryption value, in which the root encryption value is respective only to the transaction receipts or the balance receipt with respect to individual transaction records in the ledger information. That is to say, each of the ledger information is mapped to a root encryption value. If a participant account 124 or some other accounts alter or falsify the transaction receipts or the balance receipt of any transaction record in a specific ledger information, then the root encryption value would fail to map the altered transaction records in the specific a ledger information. Then, the encrypted packaging module 146 would treat each of the root encryption values as a leaf node of a Merkle tree. The encrypted packaging module 146 would keep encrypting again at least two root encryption values. The cycling encryption would keep going till the number of the root encryption value equal to 1, such that a total root encryption value is obtained. In other words, the encrypted packaging module 146 uses an encryption algorithm to perform repeating encryption orderly from a single leaf node to every level of nodes, till the last node is encrypted. Namely, the cycling encryption algorithm is executed level by level from the leaf node to the root node, and thus the total root encryption value is obtained. The foregoing encryption includes, but not limited to, the asymmetric cryptography, and the adopted algorithm includes, but not limited to, the irreversible encryption algorithm. If a participant account 124 or some other accounts alter or falsify the transaction receipts or the balance receipt of any transaction record in a specific ledger information, then the root encryption value would be altered as well. This altered total root encryption value would be never able to map the original total root encryption value. By providing the sub-ledger management, the recording and the encryption of the present invention, the ledger information can then be furnished with integrity, encryption, incorruptibility, non-repudiation and traceability, the verification can be trustable, and the trading information can be kept accurately.

In one embodiment, the encrypted packaging module 146 would keep receiving the transaction receipts with respect to individual transaction records, the transaction receipts of each transaction record would be stored through the aforesaid Merkle tree to generate a transaction receipt tree, and the total root encryption value would be transmitted to the network of a computer code protocol that can meet a requirement of able to fulfill automatically bilateral preset conditions. Then, the following participant accounts 124 would be easily verified and inspected. Similarly, the encrypted packaging module 146 would keep receiving the balance receipt with respect to individual transaction records, the balance receipt of each transaction record would be stored through the aforesaid Merkle tree so as to generate a receipt balance tree. Upon when the transaction receipt of each transaction record is received, each the transaction receipt is used to dynamically update the receipt balance tree, and the total root encryption value would be transmitted to the network of a computer code protocol that can meet a requirement of able to fulfill automatically bilateral preset conditions. Then, the following participant accounts 124 would be easily verified and inspected.

Then, the audit system 16 performs verification and inspection upon the transaction receipts or the balance receipt in the at least one ledger information of the fund transaction processing system 14. Thereby, the verification can be trustable, and the trading information can be kept accurately. Also, loss to the participants caused by fraud and error booking can be substantially reduced. In one embodiment, the audit system 16 can perform verification and inspection upon the root encryption values of the individual participant accounts 124 and the root encryption value related to the cycling encryption process, and the calculation result of the total root encryption value which is irreversible and highly difficult to be falsified is also provided to verify the consistency. If all the verifications are well, it implies that information provided by the Merkle tree, standing for the verification result, is correct. In detail, after all the transaction-term orders raised by individual participant accounts 124 have been received and fulfilled, corresponding transaction receipts would be obtained. To the transaction records corresponding to private transaction-term orders, the owner of the private transaction-term orders would have the right to audit the corresponding transaction receipts. Also, when the participant account 124 retrieves the root encryption values related to his/her own account, related encrypted information related to other participant accounts 124 would be retrieved as well. Hence, while any participant account 124 performs verification and auditing upon his/her own account, accounts of the other participant accounts 124 are also audited. As long as information of any leaf node is falsified, the derived total root encryption value would be inconsistent.

Then, the public blockchain 30 receives the total root encryption value transmitted from the encrypted packaging module 146, and the total root encryption value is recorded to a digital tag value of the j-th block in the public blockchain 30, where j>1. The digital tag value is published in a blockchain manner, highly difficult to be falsified, and always equal to the total root encryption value. In this embodiment, the audit system 16 bases on the digital tag value of the public blockchain 30 to verify the total root encryption value. Contrarily, the aforesaid encrypted packaging module 146 can only receive the total root encryption value. In the present invention, all transaction records are in the least decentralized fund trading system 10, and thus no one can peer detail information of a transaction simply by the total root encryption value recorded in the public blockchain 30. Thus, if anyone falsified the data in the conventional transmission protocol, then the derived total root encryption value would be unable to be consistent with the digital tag value of the public blockchain 30. Hence, the present invention can use the public blockchain top perform discrete storage. With the feature of open audit, the least decentralized fund trading system 10 provided by the present invention can be publicly supervised and privately supervised (by the participant). Namely, both private information of the participant and the transaction privacy can be well protected, and also safety, impartiality and transparency of the least decentralized fund trading system 10 can be true.

In summary, the least decentralized fund trading system and the method thereof in accordance with the present invention provides a low-threshold environment. By waiving the involvement of certificate brokers, transaction or management fees collected by the brokers for every transaction can be saved. The participant account can perform fund trading in an exchange on the least decentralized fund trading system of the present invention. By providing the sub-ledger management, the recording and the encryption of the present invention to the fund trading process, the ledger information can then be furnished with integrity, encryption, incorruptibility, non-repudiation and traceability, the verification can be trustable, and the trading information can be kept accurately. In addition, through the public blockchain to perform discrete storage, the least decentralized fund trading system provided by the present invention can be publicly supervised and privately supervised (by the participant). Further, safety, impartiality and transparency of the least decentralized fund trading system can be confirmed.

While the present invention has been particularly shown and described with reference to a preferred embodiment, it will be understood by those skilled in the art that various changes in form and detail may be without departing from the spirit and scope of the present invention.

What is claimed is:

1. A least decentralized fund trading system, comprising:
a money pool database, including an accommodator account and a plurality of participant accounts, each of the plurality of participant accounts being to raise transaction-term orders, each of the transaction-term orders containing at least one of a buy order and a sell order, the buy order and the sell order containing at least one fund with corresponding trading units; and
a fund transaction processing system, coupled with the money pool database, including a fund matching module, a clearing and settlement module and an encrypted packaging module;
wherein the fund matching module matches each of the transaction-term orders and generates at least one bid/ask matching information within an N-th time unit, the fund matching module pairs the buy order and an inter-offsetable sell order out of the sell order into the bid/ask matching information, and the “inter-offsetable” indicates that a predetermined conversion ratio exists in the trading units between the buy order and the sell order; wherein, for a difference existing between the buy order and the respective sell order that can't be inter-offset by the fund matching module, the accommodate account handles a reverse offset-balance operation upon the difference so as to generate corresponding bid/ask matching information, the difference is directed to the respective balance after inter-setting upon the buy order and the respective sell order, and the N is greater than or equal to 1;
wherein the clearing and settlement module receives the at least one bid/ask matching information so as further to perform a clearing process and a settlement process upon each of the at least one bid/ask matching information with respect to the corresponding transaction-term orders and the corresponding participant accounts, so that a transaction record is generated in correspondence with the at least one bid/ask matching information, the transaction record containing a transaction receipt and a balance receipt;
wherein the encrypted packaging module for receiving the transaction receipt or the balance receipt of the corresponding transaction record bases on a time series of the transaction record to record the transaction receipt or the balance receipt with respect to the transaction record into at least one ledger information, and the encrypted packaging module performs an encryption process upon the at least one ledger information so as to obtain a total root encryption value;
wherein the fund transaction processing system connects a public blockchain, the public blockchain links a plurality of blocks in a blockchain manner, the public blockchain receives the total root encryption value transmitted by the encrypted packaging module, the total root encryption value is recorded into a digital tag value of a j-th block of the plurality of blocks in the public blockchain, the j is greater than 1, and the digital tag value is equal to the total root encryption value.

2. The least decentralized fund trading system of claim 1, wherein the accommodator account trades with an exchange institution so as to obtain the fund with the trading units with respect to the difference, and performs a reverse offset-balance handle upon the difference.

3. The least decentralized fund trading system of claim 1, wherein the clearing process obtains the fund, the associated trading units of the fund, and corresponding money cleared by the clearing and settlement module with respect to the bid/ask matching information, the settlement process obtains the fund, the associated trading units of the fund, and corresponding money delivered by the participant account with respect to the bid/ask matching information, the clearing and settlement module bases on the bid/ask matching information to transfer the fund with the associated trading units among the plurality of participant accounts within the transaction-term order so as to obtain the transaction receipt, and the clearing and settlement module further transmits the transaction receipt to the participant accounts within the transaction-term order and generates corresponding balance receipt with respect to the fund with the associated trading units and the corresponding money in the transaction receipt.

4. The least decentralized fund trading system of claim 1, wherein the encrypted packaging module bases on a number of the at least one ledger information to encrypt the ledger information into a root encryption value, the root encryption value is respective only to the transaction receipt or the balance receipt with respect to the transaction record in the ledger information, the encrypted packaging module keeps encrypting again at least two said root encryption values, and a cycling encryption keeps going till the number of the root encryption values equal to 1, such that the total root encryption value is obtained.

5. The least decentralized fund trading system of claim 4, further including an audit system connected with the fund transaction processing system and the public blockchain, the audit system performing verification and inspection upon the transaction receipt or the balance receipt in the at least one ledger information of the fund transaction processing system.

6. The least decentralized fund trading system of claim 5, wherein the audit system bases on the digital tag value in the public blockchain to verify the total root encryption value.

7. The least decentralized fund trading system of claim 5, wherein the audit system performs verification and inspection upon the root encryption value corresponding to the participant account and the root encryption value related to the cycling encryption process.

8. A least decentralized fund trading method, comprising the steps of:
(a) one of a plurality of participant accounts raising a transaction-term order, the transaction-term order containing at least one of a buy order and a sell order, each of the buy order and the sell order containing at least one fund with corresponding trading units;
(b) a fund matching module being introduced to match the transaction-term order, at least one bid/ask matching information being generated within a N-th time unit, the N being greater than or equal to 1;
(c) a clearing and settlement module being used to perform a clearing process and a settlement process upon the at least one the bid/ask matching information according to the transaction-term order and the corresponding participant account, so as to generate a transaction record with respect to the at least one bid/ask matching information, the transaction record containing a transaction receipt and a balance receipt;
(d) according to a time series of the transaction record, an encrypted packaging module being used to record the transaction receipt or the balance receipt of the transaction record into at least one ledger information;
(e) the encrypted packaging module being used to perform an encryption process upon the at least one ledger information so as to obtain a total root encryption value; and
(f) the public blockchain receiving the total root encryption value transmitted by the encrypted packaging module, the total root encryption value being recorded into a digital tag value of a j-th block in the public blockchain, the j being greater than 1, the digital tag value being equal to the total root encryption value.

9. The least decentralized fund trading method of claim 8, wherein the step (b) includes the steps of:
(b1) the fund matching module pairing the buy order and an inter-offsetable sell order out of the sell order into the bid/ask matching information, the “inter-offsetable” indicating that a predeteiniined conversion ratio exists in the trading units between the buy order and the sell order; and
(b2) for a difference existing between the buy order and the respective sell order that can't be inter-offset by the fund matching module, the accommodate account handle a reverse offset-balance operation upon the difference so as to generate corresponding bid/ask matching information, the difference being directed to the respective balance after inter-setting upon the buy order and the respective sell order.

10. The least decentralized fund trading method of claim 9, wherein the reverse offset-balance handle includes a step of: the accommodator account trading with an exchange institution so as to obtain the fund and the trading unit corresponding to the difference, and then performing the reverse offset-balance handle upon the difference.

11. The least decentralized fund trading method of claim 8, wherein the step (c) includes the steps of:
(c1) the clearing and settlement module basing on the bid/ask matching information to transfer the fund with the trading units among the participant accounts corresponding to the transaction-term order and further to obtain the transaction receipt;
(c2) the clearing and settlement module transmitting the transaction receipt to the participant accounts corresponding to the transaction-term order; and
(c3) the clearing and settlement module obtaining the balance receipt according to an equivalent money and the trading units of the fund.

12. The least decentralized fund trading method of claim 8, wherein the clearing process and the settlement process of the step (c) includes the steps of:
the clearing process obtaining the fund, the associated trading units of the fund, and corresponding money cleared by the clearing and settlement module with respect to the bid/ask matching information; and
the settlement process obtaining the fund, the associated trading units of the fund, and corresponding money delivered by the participant account with respect to the bid/ask matching information.

13. The least decentralized fund trading method of claim 8, wherein the step (e) includes the steps of:
(e1) the encrypted packaging module basing on a number of the at least one ledger information to encrypt the ledger information into a root encryption value, the root encryption value is respective only to the transaction receipt or the balance receipt with respect to the transaction record in the ledger information; and
(e2) the encrypted packaging module keeping encrypting again at least two said root encryption values, and a cycling encryption keeping going till the number of the root encryption values equal to 1, such that the total root encryption value is obtained.

14. The least decentralized fund trading method of claim 8, further including the steps of:
an audit system being introduced to perform verification and inspection upon the transaction receipt or the balance receipt in the at least one ledger information; and
the audit system performing verification and inspection upon the root encryption value corresponding to the participant account and the root encryption value related to the cycling encryption process.

15. The least decentralized fund trading method of claim 8, wherein the step (e) includes a step of: the audit system basing on the digital tag value in the public blockchain to verify the total root encryption value.
